(19) United States
(12) Patent Application Publication
(10) Pub. No.: US 2007/0036130 A1
(43) Pub. Date: Feb. 15, 2007

(54) System and apparatus for network telephone switch

(76) Inventor: Teng-Yue Wang, Yonghe City (TW)

Correspondence Address: TROXELL LAW OFFICE PLLC;SUITE 1404, 5205 LEESBURG PIKE, FALLS CHURCH, VA, 22041, US

(21) Appl. No.: 11/183,792

(22) Filed: Jul. 19, 2005

(51) Int. Cl. H04L 12/66

(52) U.S. Cl. 370/352

(57) ABSTRACT

The present invention is inputted with a telephone number to detect a status of connection at a telephone device corresponding to the telephone number so that a proper telephone interconnection is established according to the status detected.

### FIELD OF THE INVENTION

The present invention relates to a telephone switch; more particularly, relates to obtaining a network telephone code for a telephone number through a contrast list to detect a status of connection at a telephone device for automatically establishing a telephone interconnection between telephone devices, which can be applied in a communication system.

### DESCRIPTION OF THE RELATED ARTS

With the development of telephone in its usage, with the increased popularity of different telephones, including the popularities in the Internet and the wireless phone, and with the various communication methods for telephone, such as SMS (Short Message System) and MMS (Multimedia Messaging Service) for mobile phone, communication workload grows tremendously so that a steady, fast and cheap communication method is wishfully in demand; and, a network telephone is of no doubt one of the preferred solutions.

Nevertheless, signals run in the network telephone are different from those run in a PSTN (Public Switched Telephone Network) system so that a network telephone according to prior arts can not dial up a PSTN telephone. To avoid no available devices for dialing out when Internet breaks, a network telephone and a PSTN telephone are both required, which results in inconvenience.

Please refer to FIG. 13, which is a view showing a telephone switch according to a first prior art. Hence, to solve the above problem, a shared dial-up device of a first prior art is proclaimed in Taiwan. The device comprises a circuit board 131, a pressing spacer 132 deposed on the circuit board 131, and a plurality of buttons deposed on a pressing part 133 of the pressing spacer 132, where the circuit board 131 comprises a plurality of circuit areas; the circuit area comprises a plurality of circuits; the pressing spacer 132 comprises a plurality of pressing parts 133 corresponding to the circuit areas; the pressing part 133 comprises a first conducting part 134 and a second conducting part 135, each conducting a network telephone or a PSTN telephone respectively, so that a shared dial-up device is obtained to dial up a network telephone or a PSTN telephone.

Please refer to FIG. 14, which is a view showing a telephone switch according to a second prior art. Again, another shared dial-up device of a second prior art is proclaimed in Taiwan. The device comprises a network telephone system 141, an isolation system 142, a PSTN telephone system 143, a PSTN dialing device 144, a first pressing member 145, a switching device 146 and a PSTN control device 147. When using a network telephone, a network connection is obtained by the network telephone system 141 to switch on the network telephone. When using a PSTN telephone, a first pressing signal from the network telephone system 141 is transmitted to the isolation system 142 and then is simulated as a pressing to switch on the PSTN telephone. When no city power is supplied, the PSTN control device 147 controls the switching device 146 to cooperate the PSTN dialing device 144 and the first pressing member 145 so that the PSTN telephone can be switched on by the first pressing member 145. Consequently, a shared dial-up device is obtained again to dial up a network telephone or a PSTN telephone. The above shared dial-up devices can dial up PSTN telephones or network telephones instead with cheaper cost; but the structures are both complex and it is still required for a user to decide which telephone is to be dialed.

Please refer to FIG. 15, which is a view showing a telephone switch according to a third prior art. As a solution to the above disadvantage, still another shared dial-up device of a third prior art is proclaimed in Taiwan. The device comprises a plurality of circuit switches 151, a control circuit 152, a plurality of client interface circuits 154, a plurality of telephone detection circuit 155 and a ringing detection circuit 156. A network communication system with the above device can dial up a network telephone or a PSTN telephone by a switching of the circuit switch 151. When an outside PSTN telephone dials in, an unused PSTN telephone among the terminals connected with the circuit switches 151 is detected by the ringing detection circuit 156 for directing the dial to the unused terminal of PSTN telephone to be answered. The above network communication system for automatically switching between PSTN phones and IP phones dials a phone call according to a predestined setup or a manually switching among the circuits, instead of the actual requirement, which requires manual interruptions and so results in inconvenience. So, the prior arts do not fulfill users' requests on actual use.

### SUMMARY OF THE INVENTION

Therefore, the main purpose of the present invention is to provide a network telephone switch which automatically detects a status of connection at a far-end telephone device for a telephone number to establish a telephone interconnection according to the detection result.

To achieve the above purpose, the present invention is a network telephone switch, comprising a near-end telephone transmitter, a telephone-code contrast list and an Internet transmitter, where, after a telephone number is inputted through the near-end telephone transmitter from a near-end telephone device, a status of connection at a far-end telephone device corresponding to the telephone number is detected and a connection is established with a proper path according to the detection result; in another word, the network telephone switch can detect a status of connection at the far-end telephone device and establish a proper telephone interconnection according to the detection result while switching automatically without any manual interruption and with cost reduced, which can be applied in a communication system. Accordingly, a novel network telephone switch is obtained.

### BRIEF DESCRIPTIONS OF THE DRAWINGS

The present invention will be better understood from the following detailed descriptions of the preferred embodiments according to the present invention, taken in con junction with the accompanying drawings, in which

FIG. 1 is a structural view of a first preferred embodiment according to the present invention;

FIG. 2 is a view showing a network structure for the first preferred embodiment according to the present invention;

FIG. 3 is a view showing a first status of use for the first preferred embodiment according to the present invention;

FIG. 4 is a view showing a second status of use for the first preferred embodiment according to the present invention;

FIG. 5 is a view showing a third status of use for the first preferred embodiment according to the present invention;

FIG. 6 is a view showing a fourth status of use for the first preferred embodiment according to the present invention;

FIG. 7 is a structural view of a second preferred embodiment according to the present invention;

FIG. 8 is a view showing a network structure for the second preferred embodiment according to the present invention;

FIG. 9 is a view showing a first status of use for the second preferred embodiment according to the present invention;

FIG. 10 is a view showing a second status of use for the second preferred embodiment according to the present invention;

FIG. 11 is a view showing a third status of use for the second preferred embodiment according to the present invention;

FIG. 12 is a view showing a fourth status of use for the second preferred embodiment according to the present invention;

FIG. 13 is a view showing a telephone switch according to a first prior art;

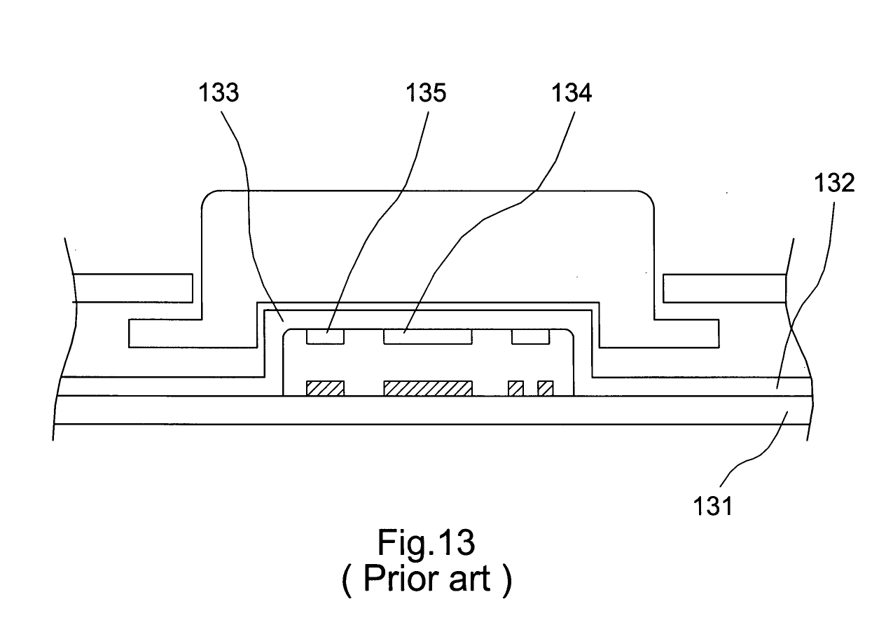

FIG. 14 is a view showing a telephone switch according to a second prior art; and

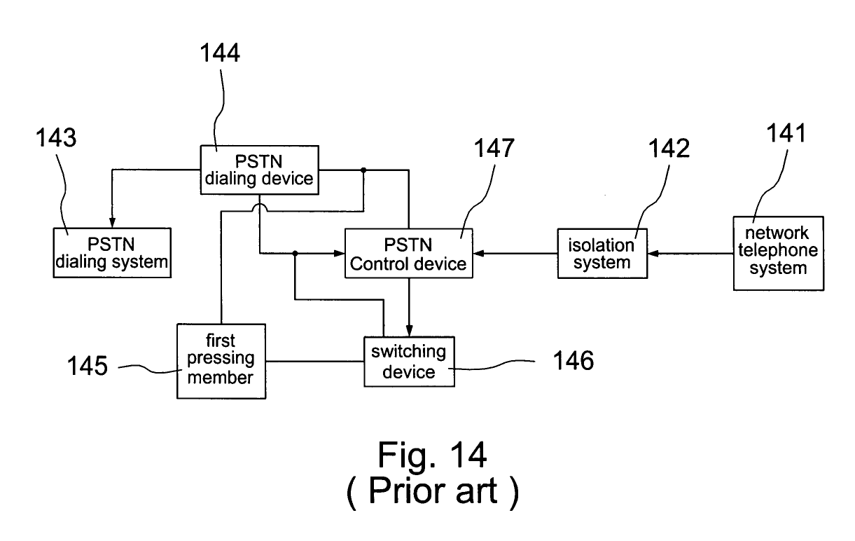

FIG. 15 is a view showing a telephone switch according to a third prior art.

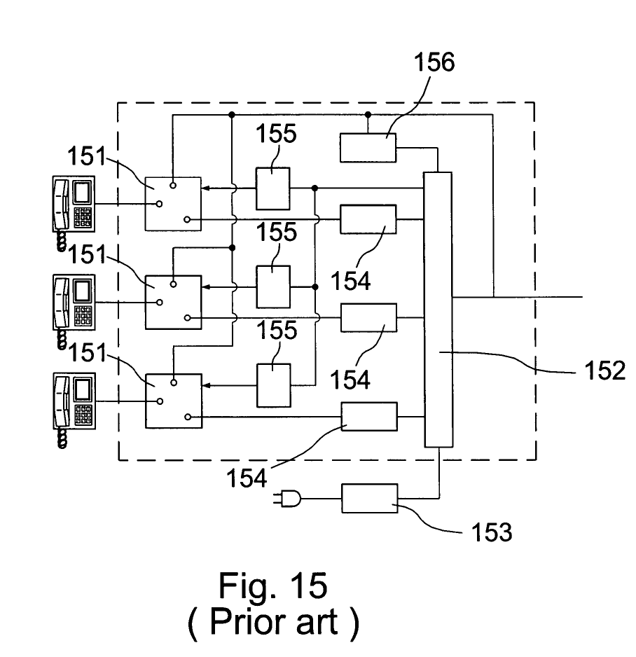

### DESCRIPTION OF THE PREFERRED EMBODIMENTS

The following descriptions of the preferred embodiments are provided to understand the features and the structures of the present invention.

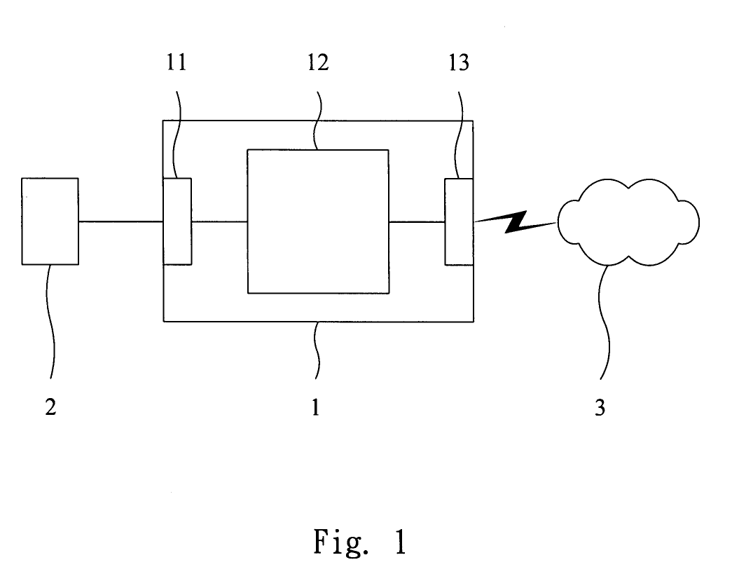

Please refer to FIG. 1, which is a structural view of a first preferred embodiment according to the present invention. As shown in the figure, the present invention is a network telephone switch 1, comprising a near-end telephone transmitter 11 connected to a near-end telephone device 2, a telephone-code contrast list 12 being a contrast list of network telephone codes for telephone numbers, and an Internet transmitter 13 connected with a webphone network 3. A telephone number is inputted from the near-end telephone device 2 through the near-end telephone transmitter 11 to the network telephone switch 1. Then, a network telephone code is obtained through the telephone-code contrast list so that a telephone interconnection is obtained between the near-end telephone device 2 and the far-end telephone device (not shown in the figure) through the Internet transmitter 13, where the far-end telephone device is corresponding to the network telephone code. Accordingly, a network telephone switch 1 is obtained where a telephone interconnection is established between the near-end telephone device 2 and the far-end telephone device through the Internet transmitter 13 over the webphone network 3.

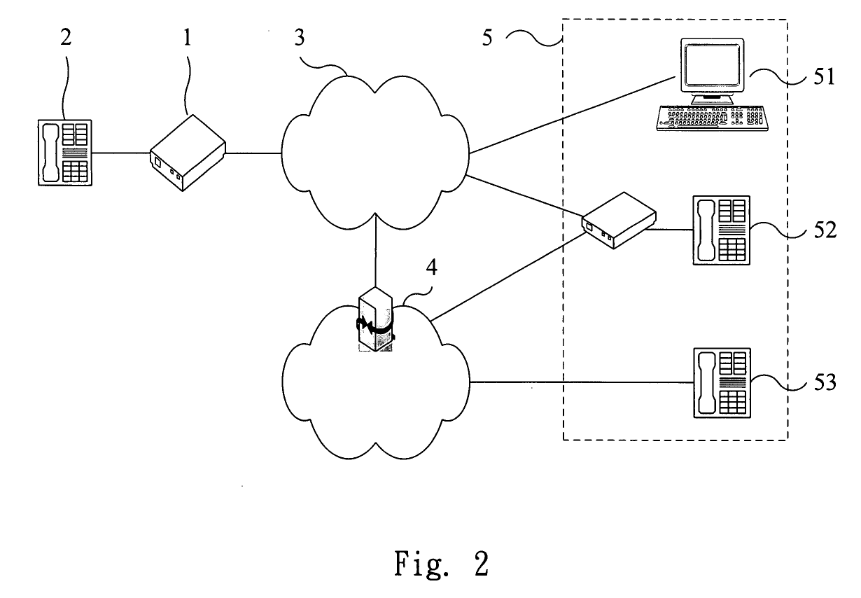

Please refer to FIG. 2, which is a view showing a network structure for the first preferred embodiment according to the present invention. As shown in the figure, a network telephone switch 1 is connected with a near-end telephone device 2 at an end, while connected with a web phone network 3 at another end to provide a connection over the webphone network 3. The webphone network 3 is connected with a PSTN (Public Switched Telephone Network) network 4 to provide a connection over the PSTN network 4 through the webphone network 3. The webphone network 3 and the PSTN network 4 are connected to a far-end telephone device 5, where the far-end telephone device 5 can be a far-end computer 51, establishing a telephone interconnection over the webphone network 3; a far-end webphone 52, establishing a telephone interconnection over the webphone network 3 or over the webphone network 3 together with the PSTN network 4; or a far-end PSTN telephone 53, establishing a telephone interconnection over the webphone network 3 together with the PSTN network 4.

When the near-end telephone device 2 dials up a telephone number for the far-end telephone device 5 through the network telephone switch 1, a network telephone code is obtained from the telephone-code contrast list 12 in the network telephone switch 1; a status of connection over the webphone network 3 is detected using the network telephone code; and, a telephone interconnection is obtained between the near-end telephone device 2 and the far-end telephone device 5 according to the status of connection detected.

The statuses of use for the telephone interconnection obtained may include, but not limited to, the following four statuses of use:

(A) A First Status of Use

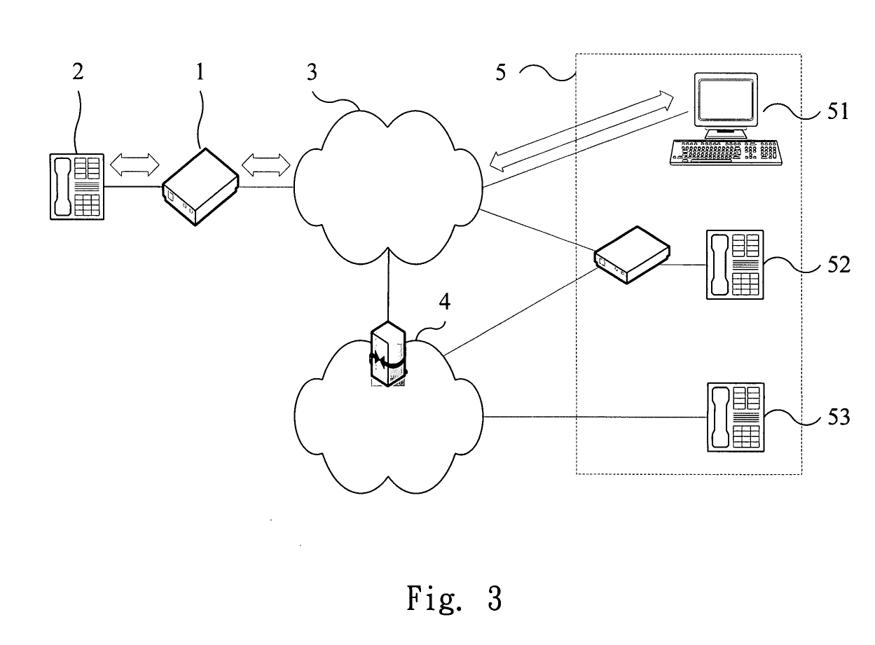

Please refer to FIG. 3, which is a view showing a first status of use for the first preferred embodiment according to the present invention. As shown in the figure, a far-end telephone device 5 is a far-end computer 51 capable of establishing a telephone interconnection over a webphone network 3. The status of connection over the web phone network 3 at the far-end telephone device 5 is found available. And, a telephone interconnection is obtained between a near-end telephone device 2 and the far-end telephone device 5 over the webphone network 3.

(B) A Second Status of Use

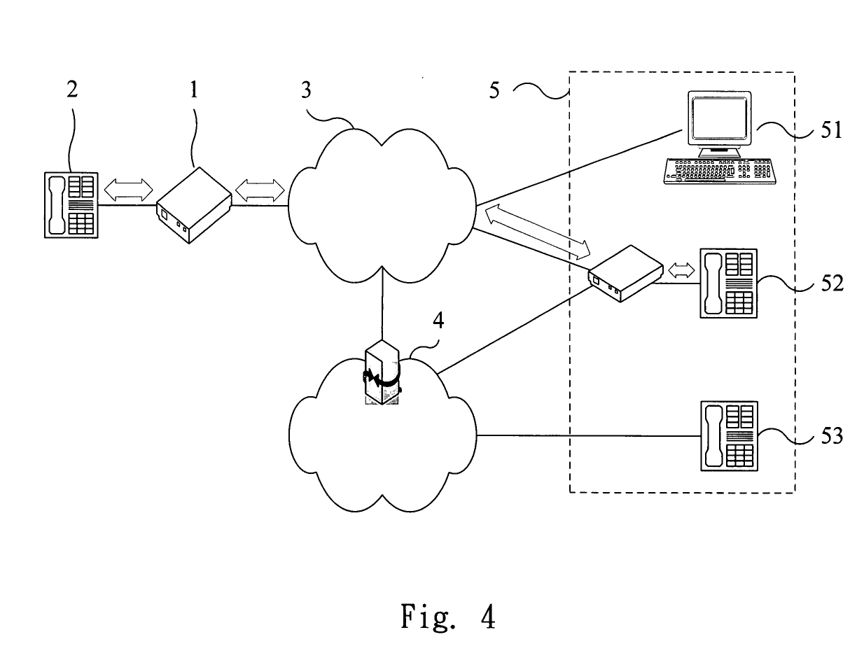

Please refer to FIG. 4, which is a view showing a second status of use for the first preferred embodiment according to the present invention. As shown in the figure, a far-end telephone device 5 is a far-end webphone 52 capable of establishing a telephone interconnection over a webphone network 3 or a PSTN network 4. The status of connection over the webphone network 3 at the far-end telephone device 5 is found available. And, a telephone interconnection over the web phone network 3 is obtained over the webphone network 3 between a near-end telephone device 2 and the far-end telephone device 5.

(C) A Third Status of Use

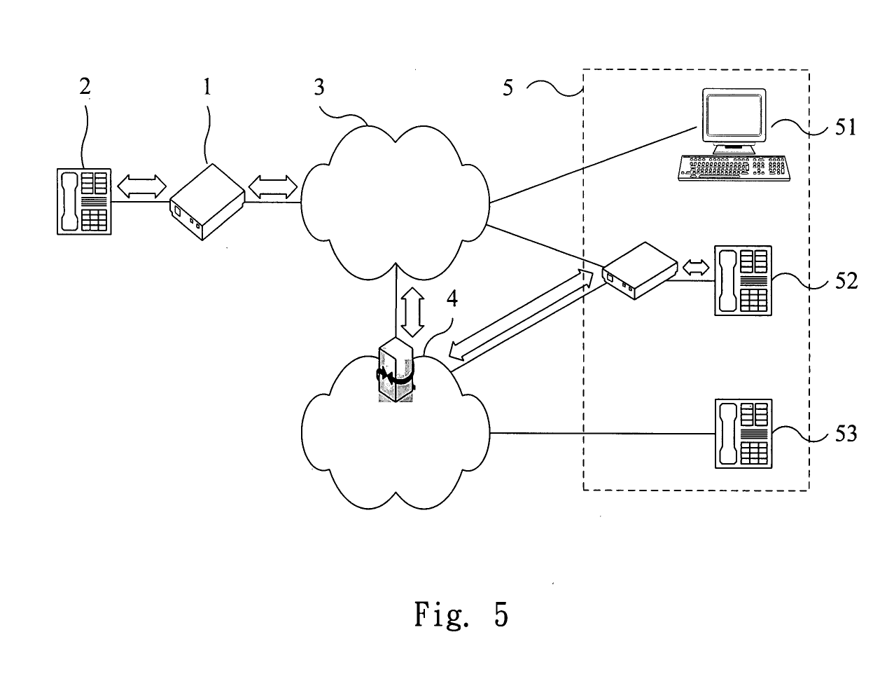

Please refer to FIG. 5 which is a view showing a third status of use for the first preferred embodiment according to the present invention. As shown in the figure, a far-end telephone device 5 is a far-end webphone 52 capable of establishing a telephone interconnection over a webphone network 3 or a PSTN network 4. The status of connection over the webphone network 3 at the far-end telephone device 5 is found unavailable. A telephone number is transmitted from a near-end telephone device 2 to the PSTN network 4 through the webphone network 3. And, a telephone interconnection is obtained between the near-end telephone device 2 and the far-end telephone device 5 over the webphone network 3 together with the PSTN network 4.

(D) A Fourth Status of Use

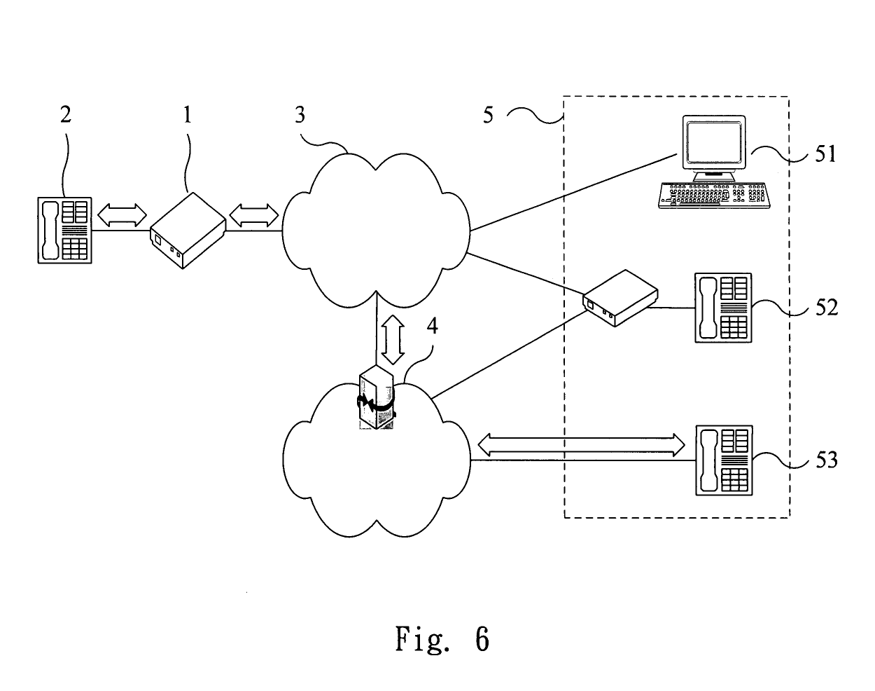

Please refer to FIG. 6, which is a view showing a fourth status of use for the first preferred embodiment according to the present invention. As shown in the figure, a far-end telephone device 5 is a far-end PSTN telephone 53. A telephone number is transmitted from a near-end telephone device 2 to a PSTN network 4 through a web phone network 3. And, a telephone interconnection is obtained between the near-end telephone device 2 and the far-end telephone device 5 over the webphone network 3 together with the PSTN network 4.

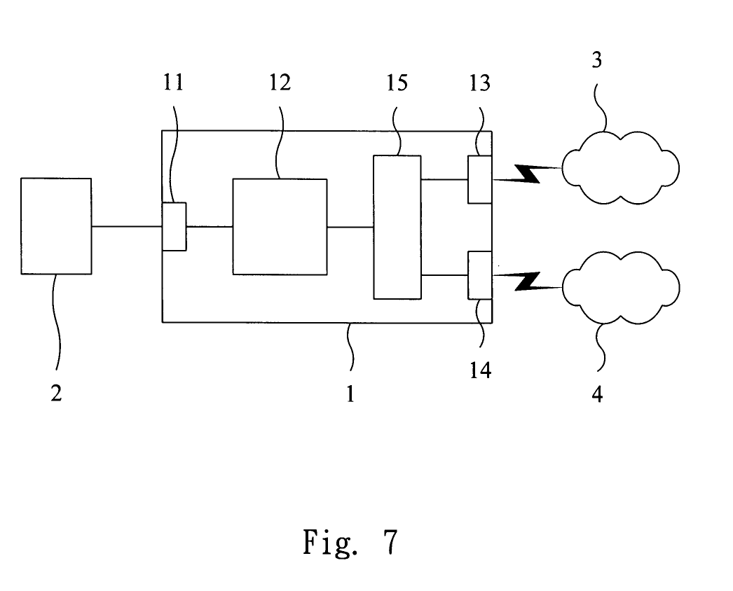

Please refer to FIG. 7, which is a structural view of a second preferred embodiment according to the present invention. As shown in the figure, according to the second preferred embodiment, the present invention is a network telephone switch, comprising a near-end telephone transmitter 11 connected to a near-end telephone device 2, a telephone-code contrast list 12 being a contrast list of network telephone codes for telephone numbers, an Internet transmitter 13 connected with a webphone network 3, a PSTN transmitter 14 connected with a PSTN network 4 and a telephone network switch 15 switching between the web phone network 3 and the PSTN network 4, where a telephone interconnection over the webphone network 3 or the PSTN network 4 can be established through the Internet transmitter 13 or the PSTN transmitter 14.

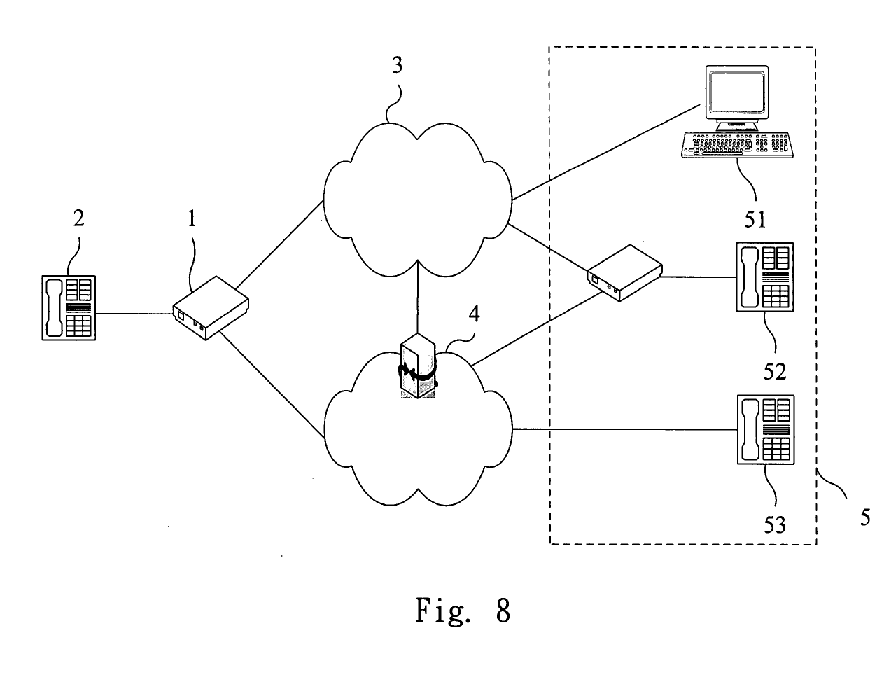

Please refer to FIG. 8, which is a view showing a network structure for the second preferred embodiment according to the present invention. As shown in the figure, a near-end telephone device 2 is connected to an end of a network telephone switch 1; the network telephone switch 1 is connected to a webphone network 3 and a PSTN network 4; the webphone network 3 and the PSTN network 4 are interconnected; and, the webphone network 3 and the PSTN network 4 are connected to a far-end telephone device 5. The far-end telephone device 5 can be a far-end computer 51, capable of establishing a telephone interconnection over the webphone network 3; a far-end webphone 52, capable of establishing a telephone interconnection over the webphone network 3 or establishing a telephone interconnection over the PSTN network 4 and a far-end PSTN telephone 53.

A network for the telephone interconnection established through the network telephone switch 1 can be selected by switching among networks with the telephone network switch 15; and the switching can be done manually or automatically. If the switching were done automatically, it is done according to the status of the webphone network 3 at the near-end telephone device 2. When the webphone network 3 is available to the network telephone switch 1, the telephone interconnection between the near-end telephone device 2 and the far-end telephone device 5 is established through the Internet transmitter 13; on the contrary, when unavailable, established through the PSTN transmitter 14.

When the networks of telephone interconnections established through the network telephone switch 1 according to the second embodiment are switched to the webphone network 3 by the telephone network switch 15, the statuses of use for the telephone interconnections are just the same as what have described in the four statuses of use for the telephone interconnections established through the network telephone switch 1 according to the first embodiment in FIG. 1 through FIG. 4.

However, when the networks for telephone interconnections established through the network telephone switch 1 are switched to the PSTN network 4 by the telephone network switch 15, the statuses of use for the telephone interconnections may be, but not limited to, the following four statuses of use:

(A) A First Status of Use

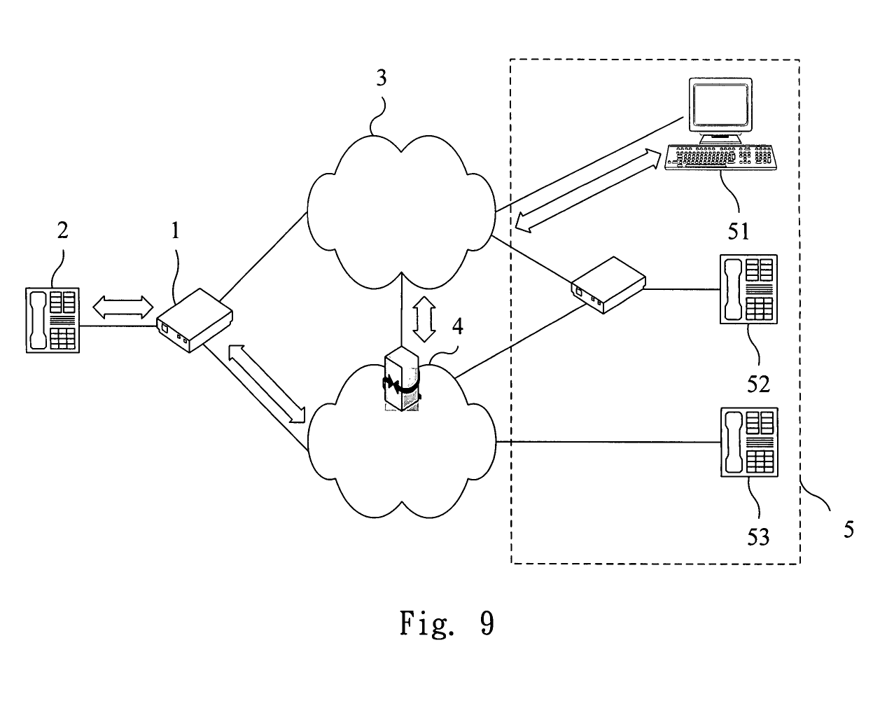

Please refer to FIG. 9, which is a view showing the first status of use for the second preferred embodiment according to the present invention. As shown in the figure, a far-end telephone device 5 is a far-end computer 51, capable of establishing a telephone interconnection over a webphone network 3. The status of connection over the webphone network 3 at the far-end telephone device 5 is available. And, the telephone interconnection between a near-end telephone device 2 and the far-end telephone device 5 is obtained over the PSTN network 4 together with the webphone network 3 by transmitting a telephone number for the far-end telephone device 5 through a PSTN network 4 to the webphone network 3.

(B) A Second Status of Use

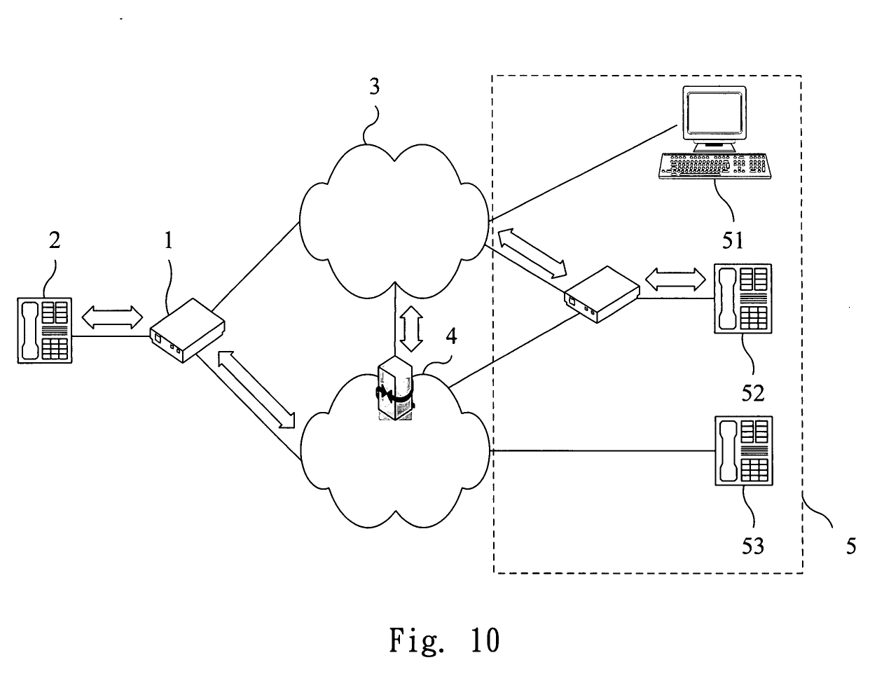

Please refer to FIG. 10, which is a view showing the second status of use for the second preferred embodiment according to the present invention. As shown in the figure, a far-end telephone device 5 is a far-end webphone 52, capable of establishing a telephone interconnection over a webphone network 3 or over a PSTN network 4. The webphone network 3 and the PSTN network 4 are interconnected. The status of connection over the webphone network 3 at the far-end telephone device 5 is available. And, the telephone interconnection between a near-end telephone device 2 or the far-end telephone device 5 is obtained over the PSTN network 4 together with the webphone network 3 by transmitting a telephone number for the far-end telephone device 5 through the PSTN network 4 to the webphone network 3.

(C) A Third Status of Use

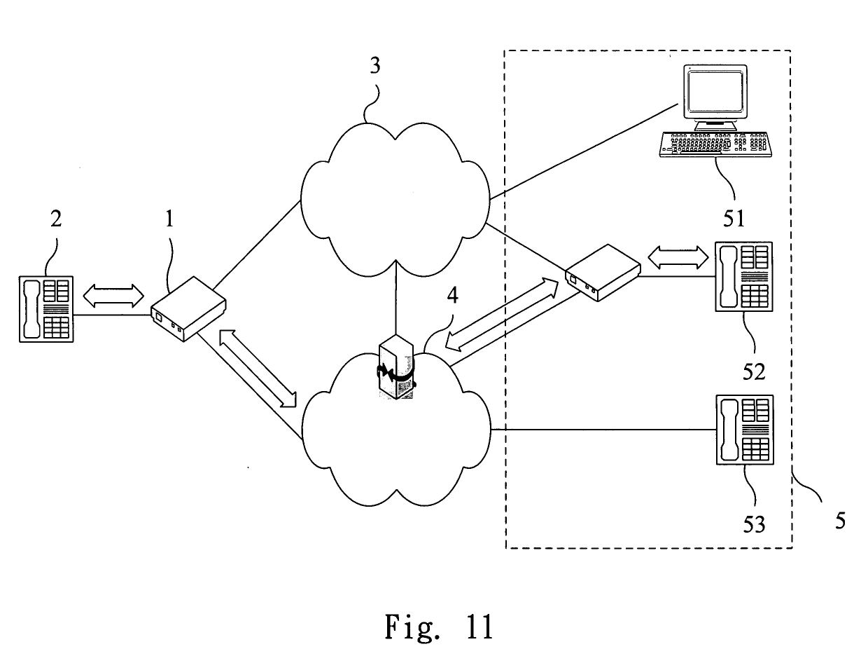

Please refer to FIG. 11, which is a view showing the third status of use for the second preferred embodiment according to the present invention. As shown in the figure, a far-end telephone device 5 is a far-end webphone 52, capable of establishing a telephone interconnection over a webphone network 3 or a PSTN network 4. The status of connection over the webphone network 3 at the far-end telephone device 5 is unavailable. And, the telephone interconnection between a near-end telephone device 2 and the far-end telephone device 5 is obtained over the PSTN network 4.

(D) A Fourth Status of Use

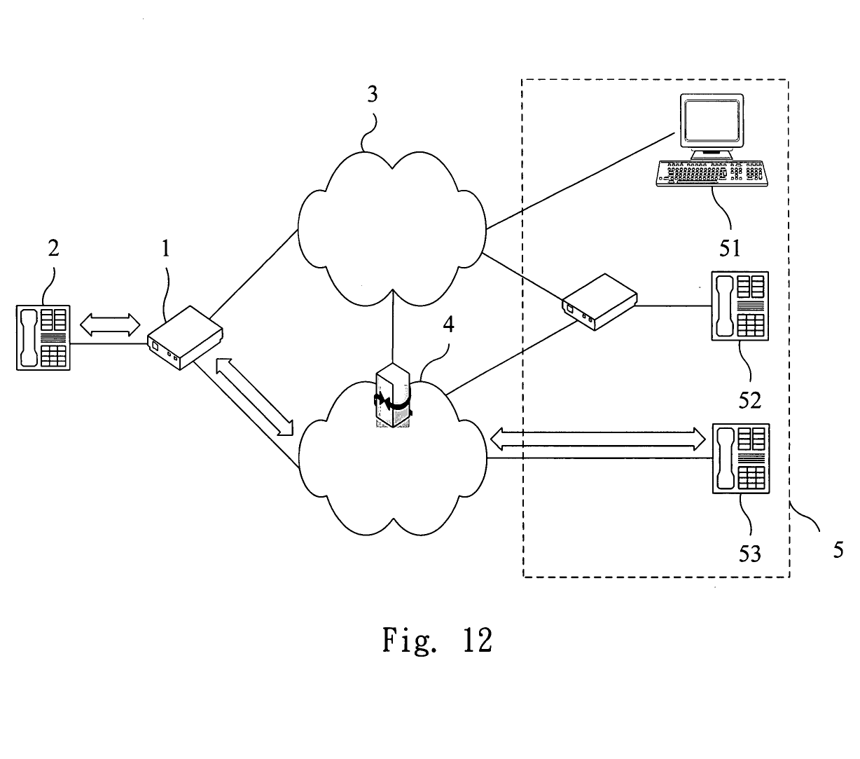

Please refer to FIG. 12, which is a view showing the fourth status of use for the second preferred embodiment according to the present invention. As shown in the figure, a far-end telephone device 5 is a far-end PSTN telephone 53. And, the telephone interconnection between a near-end telephone device 2 and the far-end telephone device 5 is obtained over the PSTN network 4.

According to the statuses of use for the first and the second embodiments described above, a proper telephone interconnection between a near-end telephone device and a far-end telephone device can be established using a network telephone switch according to the present invention, where the status of connection at the far-end telephone device can be detected to automatically establish the telephone interconnection according to the detection result with no manual interruption, ease of use and low cost.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A network telephone switch, comprising:
(1) a near-end telephone transmitter connected with a near-end telephone device;
(2) a telephone-code contrast list being a contrast list of network telephone codes for telephone numbers; and
(3) an Internet transmitter connected with a webphone network,
wherein a telephone number is inputted from said near-end telephone device to said near-end telephone transmitter;
wherein a network telephone code for said telephone number is obtained from said telephone-code contrast list;
wherein a telephone interconnection is obtained between said near-end telephone device and a far-end telephone device; and
wherein said far-end telephone device is corresponding to said network telephone code.

2. A network telephone switch system, having a network structure comprising:
(1) a near-end telephone device;
(2) a network telephone switch comprising a near-end telephone transmitter, a telephone-code contrast list and an Internet transmitter, said telephone-code contrast list being a contrast list of network telephone codes for telephone numbers, said network telephone switch connected with said near-end telephone device at an end;
(3) a webphone network connected with said network telephone switch at another end;
(4) a PSTN (Public Switched Telephone Network) network connected to said webphone network; and
(5) a far-end telephone device selected from a group consisting of a far-end computer, a far-end webphone and a far-end PSTN telephone,
wherein a telephone number is inputted from said near-end telephone device to said network telephone switch;
wherein a network telephone code for said telephone number is obtained through said telephone-code contrast list;
wherein a status of connection over said webphone network at said far-end telephone device is detected with said network telephone code;
wherein a telephone interconnection is obtained between said near-end telephone device and said far-end telephone device according to said status of connection detected; and
wherein a status of use for said telephone interconnection is selected from a group consisting of a first status of use, a second status of use, a third status of use and a fourth status of use.

3. The network telephone switch system according to claim 2, wherein said first status of use comprises that:
(a) said far-end telephone device is a far-end computer capable of establishing said telephone interconnection over said webphone network;
(b) said status of connection detected is found available; and
(c) said telephone interconnection is obtained between said near-end telephone device and said far-end telephone device through said webphone network.

4. The network telephone switch system according to claim 2, wherein said second status of use comprises that:
(a) said far-end telephone device is a far-end webphone capable of establishing said telephone interconnection over a network selected from a group consisting of said webphone network and said PSTN network;
(b) said status of connection detected is found available; and
(c) said telephone interconnection is obtained between said near-end telephone device and said far-end telephone device over said webphone network.

5. The network telephone switch system according to claim 2, wherein said third status of use comprises that:
(a) said far-end telephone device is a far-end webphone capable of establishing said telephone interconnection over a network selected from a group consisting of said webphone network and said PSTN network;
(b) said status of connection detected is found unavailable;
(c) said telephone number is transmitted from said near-end telephone device to said PSTN network through said webphone network; and
(d) said telephone interconnection is obtained between said near-end telephone device and said far-end telephone device over said web phone network together with said PSTN network.

6. The network telephone switch system according to claim 2, wherein said fourth status of use comprises that:
(a) said far-end telephone device is a far-end PSTN telephone; and
(b) said telephone number is transmitted to said PSTN network through said web phone network to obtained said telephone interconnection between said near-end telephone device and said far-end telephone device over said web phone network together with said PSTN network.

7. A network telephone switch, comprising:
(1) a near-end telephone transmitter connected with a near-end telephone device;
(2) a telephone-code contrast list being a contrast list of network telephone codes for telephone numbers;
(3) an Internet transmitter connected with a webphone network;
(4) a PSTN transmitter connected with a PSTN network; and
(5) a telephone network switch switching between connections over said webphone network and said PSTN network.

8. A network telephone switch system, having a network structure comprising:
(1) a near-end telephone device;
(2) a network telephone switch comprising a near-end telephone transmitter, a telephone-code contrast list, an Internet transmitter, a PSTN transmitter and a telephone network switch, said telephone-code contrast list being a contrast list of network telephone codes for telephone numbers, said near-end telephone device connected to said network telephone switch at an end of said network telephone switch;
(3) a webphone network connected with said Internet transmitter;
(4) a PSTN network connected with said PSTN transmitter; and
(5) a far-end telephone device selected from a group consisting of a far-end computer, a far-end webphone and a far-end PSTN telephone,
wherein a telephone number is inputted from said near-end telephone device to said network telephone switch;
wherein a network telephone code for said telephone number is obtained through said telephone-code contrast list;
wherein a status of connection over said webphone network at said far-end telephone device is detected with said network telephone code;
wherein a communication network is selected through a switching made by said telephone network switch;
wherein said communication network selected from a group consisting of said PSTN network and said webphone network;
wherein a telephone interconnection is obtained between said near-end telephone device and said far-end telephone device through said telephone network switch according to said status of connection detected; and
wherein a status for said telephone interconnection is selected from a group consisting of a first status of use, a second status of use, a third status of use and a fourth status of use.

9. The network telephone switch system according to claim 8, wherein said webphone network is in an available status and said telephone interconnection is obtained between said near-end telephone device and said far-end telephone device through said Internet transmitter.

10. The network telephone switch system according to claim 8, wherein said webphone network is in an unavailable status and said telephone interconnection is obtained between said near-end telephone device and said far-end telephone device through said PSTN transmitter.

11. The network telephone switch system according to claim 8, wherein said first status of use comprises that:
(a) said far-end telephone device is a far-end computer capable of establishing said telephone interconnection over said webphone network;
(b) said status of connection detected is found available; and
(c) said telephone interconnection is obtained between said near-end telephone device and said far-end telephone device through said webphone network.

12. The network telephone switch system according to claim 8, wherein said first status of use comprises that:
(a) said far-end telephone device is a far-end computer capable of establishing said telephone interconnection over said webphone network;
(b) said status of connection detected is found available; and
(c) said telephone interconnection is obtained between said near-end telephone device and said far-end telephone device through said web phone network together with said PSTN network after transmitting said telephone number through said PSTN network to said web phone network.

13. The network telephone switch system according to claim 8, wherein said second status of use comprises
(a) said far-end telephone device is a far-end webphone capable of establishing said telephone interconnection over a network selected from a group consisting of said webphone network and said PSTN network;
(b) said status of connection detected is found available; and
(c) said telephone interconnection is obtained between said near-end telephone device and said far-end telephone device through said web phone network together with said PSTN network after transmitting said telephone number to said PSTN network through said webphone network.

14. The network telephone switch system according to claim 8, wherein said second status of use comprises
(a) said far-end telephone device is a far-end web phone capable of establishing said telephone interconnection over a network selected from a group consisting of said webphone network and said PSTN network;
(b) said status of connection detected is found available; and
(c) said telephone interconnection is obtained between said near-end telephone device and said far-end telephone device through said webphone network.

15. The network telephone switch system according to claim 8, wherein said third status of use comprises that:
(a) said far-end telephone device is a far-end webphone capable of establishing said telephone interconnection over a network selected from a group consisting of said webphone network and said PSTN network;
(b) said status of connection detected is found unavailable;
(c) said telephone interconnection is obtained between said near-end telephone device and said far-end telephone device through said webphone network after transmitting said telephone number to said PSTN network.

16. The network telephone switch system according to claim 8, wherein said third status of use comprises that:
(a) said far-end telephone device is a far-end web phone capable of establishing said telephone interconnection over a network selected from a group consisting of said web phone network and said PSTN network;
(b) said status of connection detected is found unavailable; and
(c) said telephone interconnection is obtained between said near-end telephone device and said far-end telephone device through said PSTN network.

17. The network telephone switch system according to claim 8, wherein said fourth status of use comprises that:
(a) said far-end telephone device is a far-end PSTN telephone;
(b) said telephone number is inputted by said near-end telephone device to said PSTN network through said webphone network; and
(c) said telephone interconnection is obtained between said near-end telephone device and said far-end telephone device.

18. The network telephone switch system according to claim 8, wherein said fourth status of use comprises that:
(a) said far-end telephone device is a far-end PSTN telephone; and
(b) said telephone interconnection is obtained between said near-end telephone device and said far-end telephone device said telephone number through said PSTN network.

19. The network telephone switch system according to claim 8, wherein a connection switching made by said telephone network switch is selected from a group consisting of a manual switching and an automatic switching.

20. The network telephone switch system according to claim 8, wherein a connection switching made by said telephone network switch is an automatic switching according to a status of connection over said webphone network.
